(19) United States
(12) Patent Application Publication
(10) Pub. No.: US 2010/0027428 A1
(43) Pub. Date: Feb. 4, 2010

(54) SCHEDULING METHOD OF PROVIDING MULTIMEDIA SERVICE

(76) Inventors: Sang Bang CHOI, Incheon (KR); Kwang-Sik Shin, Incheon (KR)

Correspondence Address: NIXON & VANDERHYE, PC, 901 NORTH GLEBE ROAD, 11TH FLOOR, ARLINGTON, VA, 22203, US

(21) Appl. No.: 12/436,313

(22) Filed: May 6, 2009

(30) Foreign Application Priority Data
Aug. 4, 2008 (KR) 10-2008-0076072

(51) Int. Cl. H04L 12/56; H04L 12/26

(52) U.S. Cl. 370/241; 370/414

(57) ABSTRACT

Disclosed is a scheduling method. The scheduling method includes assigning a priority associated with a transmitted order with respect to object packets based on a delayed time remaining until the object packets are reproduced, recognizing a significance of the object packets, the significance being associated with an effect on a decoding process, and scheduling the object packets based on whether the priority is assigned to the object packets and the recognized significance. The scheduling method may perform scheduling based on the delayed time and significance, thereby effectively providing multimedia services and a data communication server.

### CROSS-REFERENCE TO RELATED APPLICATION

This application claims the benefit under 35 U.S.C. § 119(a) of Korean Patent Application No. 10-2008-0076072, filed on Aug. 4, 2008 in the Korean Intellectual Property Office, the entire disclosure of which is incorporated herein by reference.

### BACKGROUND

1. Field of the Invention

The present invention relates to a technique for effectively providing multimedia services with a high quality.

2. Description of the Related Art

A start tag and a finish tag may be calculated with respect to each packet included in a queue as shown in Equation 1 below, When an n-th packet of a flow i reaches the queue in a time A(tᵢ,n), the start tag (s_{i,n}) and the finish tag (f_{i,n}) may be respectively calculated as show in Equation 1 below, which is represented as

s_{i,n}=max{v(A(t_{i,n})),f_{i,n-1}}

f_{i,n}=s_{i,n}+L_{i,n}/r_{i,} [Equation 1]

wherein L_{i,n} represents a size of the n-th packet of the flow i.

As one of scheduling methods, a weighted fair queuing (WFQ) may select a packet of a flow whose finish tag value is the smallest after calculating the start tag and finish tag with respect to each flow.

However, in a wireless network environment, services may not be provided due to channel errors even though the packet is selected by a scheduler, whereby the services may be unevenly provided between the flows. A scheduling method used for an even resource distribution in the wireless network environment may process, as a delayed flow, a flow whose service is delayed due to the channel errors, and also process, as a leading flow, a flow to which unused resources due to channel errors of other flows are assigned to thereby be provided with services in advance. Thereafter, in the scheduling method, the unused resources may be preferentially assigned to the delayed flow, and resources corresponding to the services provided in advance may be conceded to another flow by the leading flow. Specifically, an existing scheduling algorithm may compensate resources with respect to a flow to which the resources are not assigned due to the channel error when a state of a channel becomes good, thereby evenly assigning the resources. In this instance, the compensated resources may be determined based on a size of a packet that is not transmitted due to the channel error.

In general, a multimedia stream used for multimedia services may be composed of frames having a variable length. Specifically, in the multimedia stream, a reproduced time or delayed time may act as a more important factor than the size of the packet.

The above-mentioned existing scheduling algorithm may be unsuitable for the multimedia services because the resources are simply compensated based on the size of the packet 7 without considering variable length frames and reproduced time.

### SUMMARY

Additional aspects and/or advantages will be set forth in part in the description which follows and, in part, will be apparent from the description, or may be learned by practice of the invention.

Example embodiments may provide a scheduling method which may assign a priority or weight to object packets based on a delayed time and significance of the object packets to schedule the object packets, thereby more effectively providing multimedia services.

According to example embodiments, there may be provided a scheduling method, including: assigning a priority associated with a transmitted order with respect to object packets based on a delayed time remaining until the object packets are reproduced; recognizing a significance of the object packets, the significance being associated will an effect on a decoding process; and scheduling the object packets based on whether the priority is assigned to the object packets and the recognized significance.

In this instance, the assigning may assign the priority further based on whether the object packets are packets with a multimedia data type and based on a size of the object packets.

Also, the assigning may extract, from among the object packets, a packet with the delayed time greater than a predetermined maximum allowable time, and exclude the extracted packet from the object packets to assign the priority to the object packets.

Also, the assigning may compare the delayed time of the object packets with a predetermined threshold to assign the priority.

Also, when an error or loss occurs in at least one of the object packets, the recognizing may recognize the significance based on an effect in which the occurring error or loss is exerted on reproducing and performing the object packets.

Also, the recognizing may recognize the significance with respect to the object packets based on a table in which the significance with respect to the object packets is recorded.

Also, at least one of the object packets may be multimedia data. In this instance, the multimedia data may be Moving Picture Experts Group (MPEG) data and include an I frame, a P frame, and a B frame. Also, the scheduling may assign a weight according to an order of the I frame, the P frame, and the B frame to schedule the object packets.

Also, the scheduling may schedule the object packets based on the frequencies of channels used by the object packets.

### BRIEF DESCRIPTION OF THE DRAWINGS

These and/or other aspects, features, and advantages of embodiments will become apparent and more readily appreciated from the following description, taken in conjunction with the accompanying drawings of which:

FIG. 1 is an operational flowchart illustrating a scheduling method according to example embodiments;

FIG. 2 is a conceptual diagram illustrating an I frame, a P frame, and a B frame included in Moving Picture Experts Group (MPEG) data according to example embodiments;

FIG. 3 illustrates an example of a delayed time of object packets according to example embodiments; and

FIG. 4 illustrates an example of scheduling results with respect to object packets according to example embodiments.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

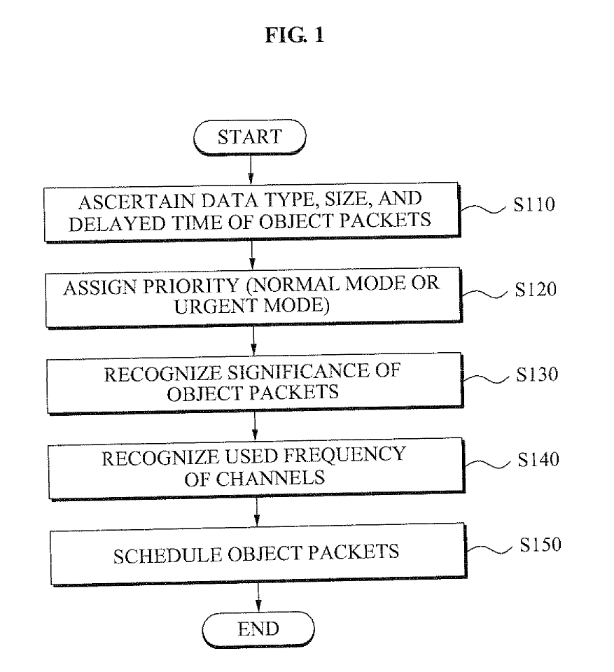

FIG. 1 is an operational flowchart illustrating a scheduling method according to example embodiments.

Referring to FIG. 1, in operation S110, the scheduling method according to an example embodiment may ascertain a delayed time remaining until object packets are reproduced, and a size and data type of the object packets.

Specifically, a delay of packet transmission in multimedia streams may be a factor directly affecting Quality-of-Service (QoS). In this instance, unlike an existing scheduling algorithm, the scheduling method according to an example embodiment may consider a delayed time or a time that can be compensated as well as a size of a delayed packet. That is, when preferentially scheduling the delayed packet, the delayed time remaining until a corresponding packet is reproduced as well as the size of the delayed packet may be considered as reference values.

Also, data may have a multimedia data type and a non-multimedia data type. The multimedia data may be moving picture data.

Also, in operation S120, the scheduling method according to an example embodiment may assign, to object packets, a priority associated with a transmission order based on the delayed time remaining until the object packets are reproduced, and the size and data type of the object packets.

Here, whether the priority is assigned to the object packets may be used as an important factor considered when determining a scheduling order.

The scheduling method according to an example embodiment may assign the priority to the object packets in any one of an urgent mode and a normal mode. The urgent mode may be applied to some packets, and the normal mode may be applied to remaining packets. In this instance, when it is assumed that other conditions are the same, the packet to which the urgent mode is applied may be more preferentially transmitted than the packet to which the normal mode is applied.

For example, multimedia data whose delayed time is larger than a threshold value may be processed using the urgent mode, and another multimedia data whose delayed time is smaller than the threshold value and non-multimedia data may be processed using the normal mode. Here, the urgent inode may designate a mode that may determine a transmission (scheduling) order so that a multimedia flow is temporally processed immediately when packet transmission, which is intended to match with a reproduction time only using resources assigned to the corresponding flow, is ascertained to be impossible. Conversely, the normal mode may designate a mode that may determine the transmission order based on the start tag and delayed time under identical conditions regardless of data type.

In the normal mode, a service tag of each flow may be calculated as shown in Equation 2 below, which is represented as

T_{S}=S(pᵢ^{k})+L(pᵢ^{k})/rᵢ−dᵢ·β+R(0). [Equation 2]

In Equation 2, S(pᵢ^{k}) and L(pᵢ^{k})/rᵢ may be identical to a value indicating a finish tag in an existing weighted fair queuing (WFQ). S(pᵢ^{k}) may designate a start tag, and have a larger value of a time utilized until a k-th packet of an i-flow reaches a queue and a time utilized for transmission completion of a (k−1)-th packet of the i-flow, and L(pᵢ^{k})/rᵢ may designate a time utilized in transmitting the k-th packet, and may be a band corresponding to a weight assigned to the i-flow. Also, dᵢ in a case of multimedia data may designate a time during which the i-flow is delayed on the basis of a reproduction time, and also dᵢ in a case of the non-multimedia data may designate a time during to which the i-flow remains in the queue because the non-multimedia data may not have the reproduction time. Also, β may designate a weight value indicating a weight of a delayed time when calculating the service tag, and R(0) may designate a constant.

In the urgent mode, the service tag of the multimedia flow may be calculated as shown in Equation 3 below, which is represented as

Tₛ=S(pᵢ^{k})+L(pᵢ^{k})/rᵢ+Bᵢ^{k}−dᵢ+R(T(pᵢ^{k})). [Equation 3]

In the urgent mode unlike the normal mode only considering dᵢ, the transmission (scheduling) order may be determined depending on Bᵢ^{k}-dᵢ. For example, since Bᵢ^{k} may designate a maximum allowable time being allowable to the i-flow, a flow whose remaining maximum allowable time is relatively small may be selected.

R(T(pᵢ^{k})) may be a constant, and used in determining the transmission order depending on a frame type or significance of the packet. Since the constant varying according to each frame type may satisfy ‘R(0)□R(B)□R(P)□R(I)’, the flow of the urgent mode may be scheduled prior to the multimedia flow of the normal mode. This will be described in detail below, however, the scheduling method according to the present example may perform scheduling based on whether a priority is assigned to object packets (whether the urgent mode or the normal mode is applied to the object packet), and significance determined according to types of the data packets.

Also, in operation S130, the scheduling method according to an example embodiment may recognize a significance of the object packets, which is associated with an effect on a decoding process.

As described above, R(T(pᵢ^{k})) of Equation 3 may be used as a factor indicating the significance. In this instance, the scheduling method according to an example embodiment may manage and maintain a table where the significance of the object packets is recorded, and the significance of the object packets may be recognized using the table.

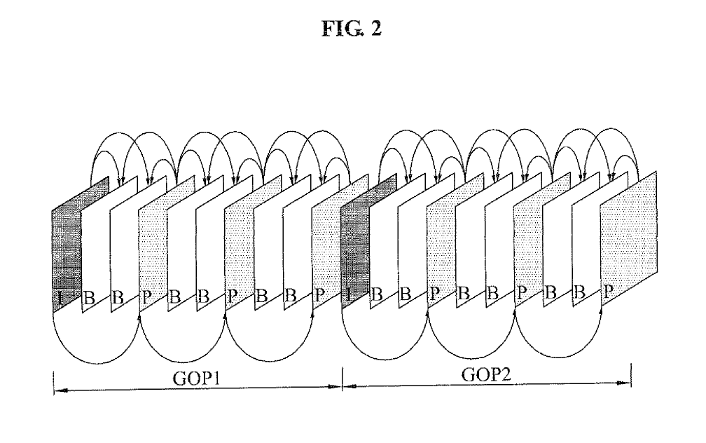

When an error or loss occurs in at least one of the object packets, the significance may be associated with an effect in which the occurring error or loss is exerted on reproducing and performing the object packets. This will be described in detail with reference to FIG. 2.

Also, in operation S140, the scheduling method according to an example embodiment may recognize a used frequency of channels used by the object packets.

In this instance, when other conditions are the same, a packet using a channel whose used frequency is relatively small may be preferentially transmitted.

In operation S150, the scheduling method according to an example embodiment may schedule the object packets based on whether the priority is assigned to the object packets (whether the urgent mode or normal mode is applied to the object packets), the significance, and the used frequency of the channels.

For example, the scheduling method according to an example embodiment may preferentially transmit a packet with the highest significance and smallest used frequency from among the object packets to which the urgent mode is applied.

FIG. 2 is a conceptual diagram illustrating an I frame, a P frame, and a B frame included in Moving Picture Experts Group (MPEG) data according to an example embodiment.

MPEG-4 may support various additional functions in comparison with existing MPEG-1 and MPEG-2, however, may be similar to the MPEG-1 or MPEG-2 with respect to transmitting/receiving of natural images via a radio channel, and an algorithm of restoring compressed data and a method of configuring video data.

The MPEG may use a method of storing only a reference image and a difference image between frames on the basis of the reference image. In this instance, when a loss occurs in an I frame, that is, the reference image of a specific group of picture (GOP), an effect of the loss may be exerted on all frames within the specific GOP. Here, GOP may be a set of I, P, and B frames, and a set unit of independent image frames prevented from being affected by other GOPs.

The loss of the P frame may affect B frames located in the front and rear of the P frame, and all P frames within the following GOP, and the loss of the B frame may not affect other frames. Accordingly, in the MPEG, a priority of packets included in an entire video stream may vary according to types of the packets.

The I frame where an intra-coding scheme is applied may use various data compression coding schemes utilizing only information included in the I frame.

Referring to FIG. 2, a GOP structure of the MPEG is conceptually illustrated. Each of arrows of FIG. 2 may designate a direction of a corresponding frame when each frame is decoded. Consecutive frame sets within a sequence may generally have significantly similar characteristics with each other in front and rear frames with respect to a specific frame. By utilizing the above-mentioned characteristics, obtaining the V and B frames using differences between neighboring images over time may designate an inter-frame coding. Since the GOP starts with the I frame, an encoder may predict and process a following frame. In general, the encoder may predict the following frame based on the P frame using a forward reference over time. The B frame having a bidirectional reference may consider prior/posterior I frames or P frames. Characteristics of each frame may be summarized as below.

The I frame may use an intra-frame coding scheme of coding based on information of a corresponding frame while not considering other frames, and may be the largest frame and include a large amount of information.

The P frame may only be coded using only changed information based on a prior I frame or P frame, and may be smaller than the I frame and include a relatively smaller amount of information in comparison with the I frame.

The B frame may include information used only for compensating for a difference between the I frame and P frame, and have a relatively lower priority of the information due to not considering other frames.

As described above, MPEG data may have different priorities for each frame type because of an amount of information included in each frame and a difference between coding schemes. Accordingly, when transmitting moving pictures using MPEG compression, protecting the I frame from congestion generated on network terminals is important.

In this instance, the scheduling method according to the present example embodiment may assign a priority or weight to the I frame to preferentially transmit a packet of the I frame, thereby protecting the I frame.

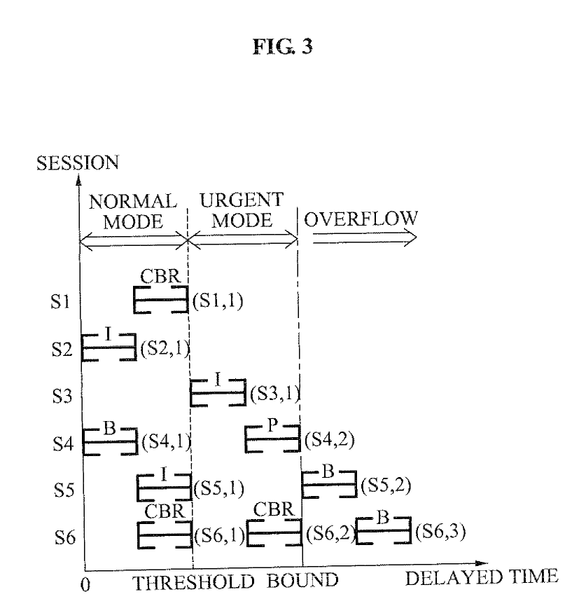

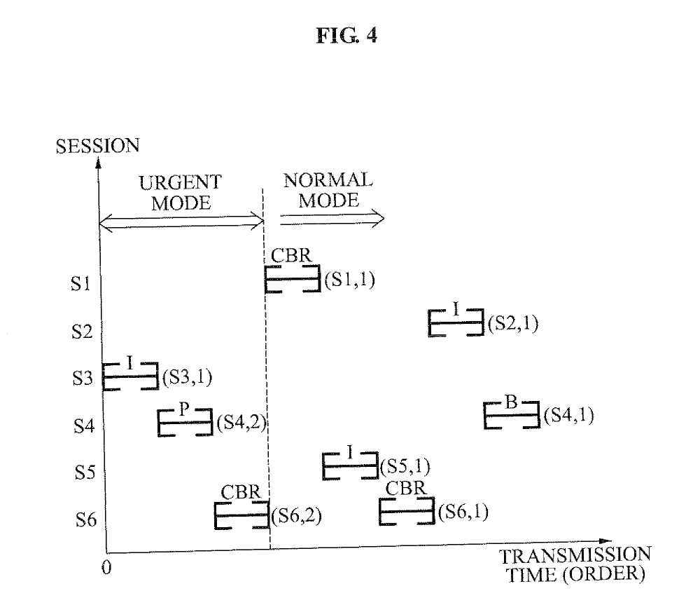

FIG. 3 illustrates an example of a delayed time of object packets, and FIG. 4 illustrates an example of scheduling results with respect to object packets according to an example embodiment.

Referring to FIG. 3, a constant bit rate (CBR) may designate a general data packet (non-multimedia data different from multimedia data), and I, P, and B may designate a packet included in I, P, and B frames of the multimedia data, respectively.

A B (S5, 2) frame packet in a session 5 (S5) and a B (S6, 3) packet in an S6, each whose delayed time is larger than a maximum allowable time (Bound), may be determined as overflow to thereby be eliminated from a queue. A maximum allowable time in the non-multimedia data may be designated as a time during which a packet is able to remain in the queue, that is, a time before the overflow occurs in a queue assigned to a corresponding flow.

Three packets (S6, 1, S6, 2, and S6, 3) of the S6 may be non-multimedia data that is not affected by a reproduction time, and processed in a normal mode provided that the maximum allowable time is not exceeded even when the delayed time is larger than a threshold value. Accordingly, the S6, I and S6, 2 may be processed as the normal mode.

An I frame packet (S3, 1) of an S3 and a P frame packet (S4, 2) of an S4 may be processed in an urgent mode, and have relatively higher significances than other packets, whereby the I frame packet (S3, 1) and the P frame packet (S4, 2) may be preferentially scheduled in comparison to the other packets.

In the urgent mode, the priority may be determined according to a type (significance) of a frame in which a packet is included regardless of the delayed time. A significance order of the MPEG data may satisfy I>P>B, whereby the I frame packet (S3, 1) of the S3 and the P frame packet (S4, 2) of the S4 may be scheduled as the stated order.

In the normal mode, the scheduling order of the MPEG data may be affected by the type of the data packet, whereby a following scheduling order may be determined according to the delayed time and a used frequency of a channel. In FIG. 4, the scheduling order according to the present example embodiment is illustrated when it is assumed that a size of each packet is the same.

In the normal mode, a delayed time of a CBR (S6, 1) of the S6 is identical to delayed times of packets of an S1 and the S5, however has a record of previously using a channel, whereby a scheduling order of the CBR (S6, 1) is the latest among three CBRs.

A packet (S1. 1) of the S1 and an I frame packet (S5. 1) of the S5 may have an identical delayed time to each other, and both of the S1 and S5 do not have a record of previously using a channel, and thereby either of both packets may be selected. Also, a packet of the S2 and a B frame packet of the S4 may have a delayed time identical with each other, however the S4 has a record of previously using a channel for transmitting the P frame packet, and thereby the packet of the S2 may be preferentially transmitted.

The scheduling method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

As described above, according to the present example embodiments, a weight or priority may be assigned to the object packets based on delayed times and significances of the object packets to schedule the object packets, thereby more effectively providing multimedia services.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A scheduling method, comprising:
assigning a priority associated with a transmitted order with respect to object packets based on a delayed time remaining until the object packets are reproduced;
recognizing a significance of the object packets, the significance being associated with an effect on a decoding process; and
scheduling the object packets based on whether the priority is assigned to the object packets and the recognized significance.

2. The scheduling method of claim 1, wherein the assigning assigns the priority further based on whether the object packets are packets with a multimedia data type and based on a size of the object packets.

3. The scheduling method of claim 1, wherein the assigning extracts from among the object packets, a packet with the delayed time greater than a predetermined maximum allowable time, and excludes the extracted packet from the object packets to assign the priority to the object packets.

4. The scheduling method of claim 1, wherein the assigning compares the delayed time of the object packets with a predetermined threshold to assign the priority.

5. The scheduling method of claim 1, wherein, when an error or loss occurs in at least one of the object packets, the recognizing recognizes the significance based on an effect in which the occurring error or loss is exerted on reproducing and performing the object packets.

6. The scheduling method of claim 1, wherein the recognizing recognizes the significance with respect to the object packets based on a table in which the significance with respect to the object packets is recorded.

7. The scheduling method of claim 1, wherein at least one of the object packets is multimedia data, the multimedia data being Moving Picture Experts Group (MPEG) data and including an I frame, a P frame, and a B frame, and wherein the scheduling assigns a weight according to an order of the I frame, the P frame, and the B frame to schedule the object packets.

8. The scheduling method of claim 1, wherein the scheduling schedules the object packets based on a used frequency of channels used by the object packets.

9. At least one medium comprising computer readable instructions implementing the method of claim 1.
